(19) United States
(12) Patent Application Publication
(10) Pub. No.: US 2010/0325926 A1
(43) Pub. Date: Dec. 30, 2010

(54) MARKING DEVICE FOR IDENTIFYING AND MARKING ANIMALS, AND MALE COMPONENT OF SUCH DEVICE

(76) Inventors: Jean-Jacques Hilpert, Vitre (FR); Emmanuel Lemaire, Mont D'Origny (FR)

Correspondence Address: KAUTH , POMEROY , PECK & BAILEY ,LLP, 2875 MICHELLE DRIVE, SUITE 110, IRVINE, CA, 92606, US

(21) Appl. No.: 12/747,158

(22) PCT Filed: Dec. 11, 2008
(86) PCT No.: PCT/EP08/67354

§ 371 Date: Aug. 20, 2010

(30) Foreign Application Priority Data
Dec. 12, 2007 (FR) 07/59786

(51) Int. Cl. A01K 11/00

(52) U.S. Cl. 40/301; 40/300

(57) ABSTRACT

The invention relates to a marking device for identifying and marking an animal that is connected by a non-reversible engagement: a male portion (2) including a rod extending from a holder (10); and a female portion (5) including a cavity for interaction with a rod. According to the invention, the rod is surrounded at least partially with a foam (21) impregnated with a specific substance so that the foam (21) is compressed upon the engagement of said male and female portions

### FIELD OF THE INVENTION

The field of the invention is that of identifying and marking animals.

More precisely, the invention relates to a marking device, or tag, for identifying and marking farm animals, making it possible to treat animals. The invention in particular proposes an ear tag making it possible to avoid infections during the application of the tag and of the cicatrisation of the ear of the animal.

### PRIOR ART

The identification of livestock was rendered mandatory in many countries in order to provide for the monitoring of the heard and guarantee the origin of the animals intended in particular for consumption. This marking concerns bovine as well as ovine, porcine or goats.

Conventionally, a tag includes an identification number inscribed on a label allowing the animal to be monitored all throughout its existence. For example, in accordance with European Directive 1760/2000, all bovine must be identified by an ear tag affixed to each ear, with both tags bearing the same unique identification code which makes it possible to identify each animal individually, as well as the farm where it was born. These tags must therefore be tamper proof in order to provide for the traceability of the animal, i.e. it must not be possible to remove a tag affixed to a first animal in order to re-install it on a second animal.

Ear tags made of plastic are the most commonly used. They include a loop bearing a label whereon is mentioned all of the legal data by printing or engraving, by laser marking, or any other means known to those skilled in the art. They are designed to be installed irreversibly, using a system of tamper proof fastening, associating in a snap locking arrangement a male component passing through the ear of the animal and a female component.

In addition to the constraints of inviolability, it is desirable to use tags that favour cicatrisation and avoid the infections on the wound formed in the ear of the animal, in particular to reduce the risks of suffering of the animals. Indeed, the opening made in the ear represents a source of infection wherein microorganisms, present for example on the farm where the animal is located, can develop and penetrate into the organism of the animal.

As such, EP 0 212 885 filed in the name of Sterimatic Holdings Limited has proposed to add a reservoir including a substance, for example a sterilising substance, to the female component of the tag.

According to this approach, a specific applicator is used comprising two jaws, one of them bearing a punch making it possible to pierce the ear of the animal.

More precisely, during the application of the tag, the punch is introduced into the male component, in order to first pierce the ear of the animal, then the membrane seal of the reservoir located in the female component, thus making it possible to release the sterilising substance.

This approach therefore requires the use of a male component comprising a hollow pin, wherein the punch is introduced.

Unfortunately, this technique is not very effective. Indeed, the male component is introduced into the female component practically at the same time that the punch penetrates the membrane seal. Consequently, the sterilising substance is at least partially blocked into the female component, and cannot reach the wound in order to disinfect it effectively.

Another disadvantage of this technique is that a reservoir (increasing the size of the tag and making its production and is implementation more complex) and a membrane seal closing this reservoir must be provided.

Furthermore, this membrane seal, even pierced by the punch, hinders an effective and complete distribution of the substance.

There is therefore a need for a new technique making it possible to avoid infections on the wound formed during the application of the tag, or at the very least to improve the implementation and the effectiveness of the corresponding treatment, in relation to the known techniques.

### DESCRIPTION OF THE INVENTION

The invention proposes a new solution which does not have all of these disadvantages of prior art, in the form of a marking device for identifying and marking an animal, associating in a snap locking arrangement:
a male component including a pin extending from a base, and
a female component including a cavity intended to interact with said pin.

According to the invention, the pin is surrounded at least partially with a foam impregnated with a specific substance, so that the foam is compressed upon the engagement of said male and female components.

In other terms, the pin is surrounded at least partially with a foam that is able to be compressed between the skin of the animal to be marked and the base, and is able to release a specific substance in contact with the wound formed by the pin, upon the engagement of the male and female components.

As such, the invention proposes a new tag comprising, on its male component, a foam impregnated with a specific substance prior to the application of the tag.

The use of an impregnated foam on the male component of the marking device, makes it possible to ensure, upon the application of the tag, the application of the substance directly on the skin of the animal. Indeed, when the pin of the male component passes through the skin of the animal (conventionally the ear) to then become housed in the female component, the foam is squashed between the base and the skin of the animal, and releases the specific substance.

The substance is as such applied directly on the wound created by the pin, or a tip at the end of the pin, and in the vicinity of the latter, limiting the losses of substance.

In addition, the marking device according to the invention remains compatible with the conventional applicators, such as the “Total Tagger” (registered trademark) applicator, which allows the tag with or without foam to be installed.

It can be noted that the foam can fully surround the pin or surround it only partially, by means of one or several portions of foam. The quantity of foam and of substance on the male component can as such be limited and optimised.

In particular, the specific substance can be an antiseptic substance, making it possible to destroy at least partially the microorganisms (bacteria, viruses, etc.) that can cause infections on the opening made upon the application of the tag. This substance can in particular have the form of a gel, a cream, or a liquid impregnating the foam.

It can also entail a medication or a vaccine making it possible to care for or treat the animal (or a combination of these products), this substance being able to pass into the blood on the wound or to be absorbed by the skin of the animal.

As such, by reducing the risks of infection and the forming of abscesses, at the same time the risks of suffering are reduced for the animals and the state of health in the farm is improved. Adapted care can furthermore be administered, in case of need.

According to a particular characteristic of the invention, a lower face of the foam is fastened to the base, for example by gluing. It is as such possible to manufacture male components bearing such a foam. If it is desired to reduce the thickness of the foam used, it is also possible to add a buffer element between the base and the foam, and to fasten the foam to the base by the intermediary of the buffer element.

According to a first embodiment, the foam fully surrounds the pin, over a thickness less than or equal to the length of the pin.

In this case, the foam can be of a substantially cylindrical form, with the pin forming the axis of the cylinder, and may have one or several hollows on its upper face, i.e. on its face opposite the base.

The contact between the foam and the skin of the animal is as such reduced, which makes it possible to improve the distribution of the specific substance. The squashing of the foam and the release of the substance can as such be optimised. In addition, this structure makes it possible to optimise the circulation of air around the wound, which as such favours the cicatrisation thereof.

For example, these hollows form concentric crowns, around the pin.

According to a second embodiment, the foam covers the end of the pin opposite the base.

For example, the foam forms a tube surrounding the pin, and closed on the end of the pin. As such, the end of the pin, terminating with a tip for example, is protected from the outside environment before the application of the tag.

Upon application, the tip pierce the foam, then the skin of the animal, for example its ear, before becoming housed, irreversibly, in the cavity of the female component. The foam located along the pin is also compressed upon the application, releasing the specific substance.

As such, when the specific substance is an antiseptic substance, the pin of the male component is sanitized before piercing the ear of the animal, which makes it possible to further reduce the risks of infection.

Other forms, for example substantially cone-shaped or truncated cone-shaped, are possible. Several portions of foam distributed on the base can also be provided.

According to a particular characteristic of the invention, the foam is protected by a protective film, before the application of the tag. Such a film makes it possible in particular to avoid the drying of the specific substance, prior to installing the tag on the animal.

In particular, the marking device can be an ear tag.

Such a tag can be affixed to each ear of the animal, at a well-defined place in the ear, in accordance with European Directive 1760/2000.

Another aspect of the invention also relates to the male component of a marking device for identifying and marking of an animal, such as described hereinabove, and associating in a snap locking arrangement:
a male component including a pin extending from a base, and
a female component including a cavity intended to interact with the pin.

According to the invention, the pin is surrounded at least partially with a foam impregnated with a specific substance, so that the foam is compressed upon the engagement of said male and female components.

Such a male component is in particular able to interact with a female component such as presented hereinabove. This male component can of course comprise the various characteristics relative to the marking device according to the invention.

### LIST OF FIGURES

Other characteristics and advantages of the invention shall appear more clearly when reading the following description if a particular embodiment, provided as a simple non-restricted example, and of the annexed drawings, wherein:

FIG. 1 shows in a simplified manner the general structure of a marking device of a known type;

FIGS. 2A and 2B show a first embodiment of the invention, according to which the pin is surrounded by a cylindrical foam;

FIG. 3 shows a tag affixed on the ear of an animal, according to this first embodiment;

FIGS. 4A and 4B show an alternative of the first embodiment;

FIGS. 5A and 5B show a second embodiment of the invention, according to which the tip of the pin is also covered with a foam; and

FIG. 6 shows a tag affixed on the ear of an animal, according to this second embodiment.

### DESCRIPTION OF AN EMBODIMENT OF THE INVENTION

The general principle of the invention is based on the use of a foam, of the polyurethane type for example, impregnated with a specific substance, for example an antiseptic, before the tag is installed. Such a foam is placed on the male component of a marking device, such that upon the engagement of the male and female components of the tag, the foam is squashed between the skin of the animal to be marked and the base of the male component, thus spreading the specific substance on the skin of the animal, in contact with the wound formed upon the engagement of the male and female components.

Hereinbelow an ear tag shall be described, intended to be affixed on the ear of an animal, for example of the bovine, ovine, porcine or goat type. Other locations on the body of the animal can also be considered for a tag according to the invention.

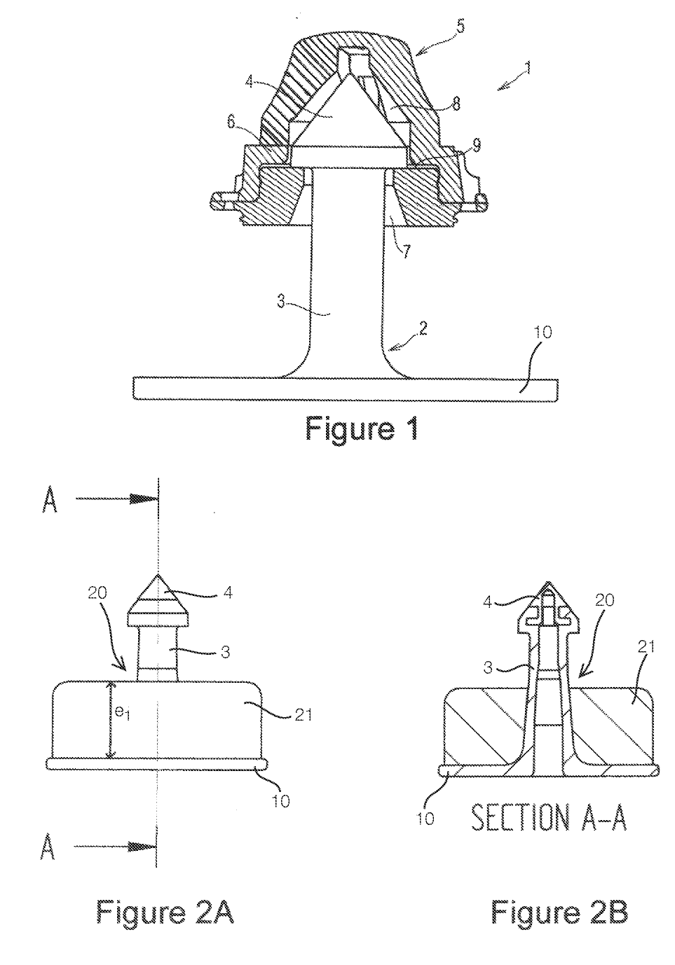

Firstly, an example of a marking device with a general structure of a known type is presented, as shown in a simplified manner in FIG. 1. Such a device connects by a non-reversible engagement a male component 2 including a pin 3 and a female component 5 including a reception button 6. The male 2 and female 5 components are engaged using an applicator which makes it possible to insert the pin 3 into the reception button 6 by perforating the skin of the animal, for example the ear. More precisely, the pin 3 of the male component 2 extends from a base 10 intended to rest on a face of the ear of the animal, perpendicular (or substantially perpendicular) to this base. This pin 3 is terminated by a tip 4 making it possible to pierce the ear of the animal.

Concerning the female component 5, the reception button 6 has an orifice 7 and a cavity 8 for the introduction of the tip 4 of the pin 3. The base of the female component can rest on the other face of the ear.

Once the tag 1 is installed, the tip 4 is housed in the cavity 8, and is maintained therein by a retaining shoulder 9 creating the transition between the cavity 8 and the orifice 7. It is therefore no longer possible to remove the tag, or to modify it, without breaking it once it has been installed.

Such tags bear small marked plates or labels identifying the animal. In particular, the button can contain a small plate providing a marking surface for the identification of the animal.

These tags can also, where applicable, be provided with electronic means of identification, such as a transponder or analogous device, housed for example inside the button. These are normally manufactured from a plastic material, but can also be made of aluminium or of steel.

It can be noted that several alternatives of the structure of this marking device have been proposed. Of course, the invention is not limited to the structure described hereinabove, but also applies to these alternatives.

In relation with FIGS. 2A and 2B, the male component of an ear tag is now presented according to a first embodiment of the invention. More precisely, FIG. 2A shows a profile view of the male component 20 of a marking device according to this embodiment of the invention, and FIG. 2B shows a cross-section view according to the section AA of this same component.

According to this first embodiment, the pin 3 is fully surrounded with a foam 21 impregnated with a specific substance, over a thickness e₁ less than or equal to the length of the pin. The foam thus has a cylindrical form, with the pin forming the axis of the cylinder.

For example, the foam is a cellular plastic material.

Preferentially, the thickness e₁ of the foam is chosen to be sufficiently thick enough so that the foam is squashed between the base 10 and the ear upon the engagement of the male and female components.

For example, if a pin of 20 mm in length is considered, with the pin penetrating 6 to 8 mm in the cavity 8, and if an ear thickness of the animal of a magnitude of 5 mm is considered, then the foam 21 can have a thickness greater than 9 mm, in order to be effectively compressed upon the application of the tag.

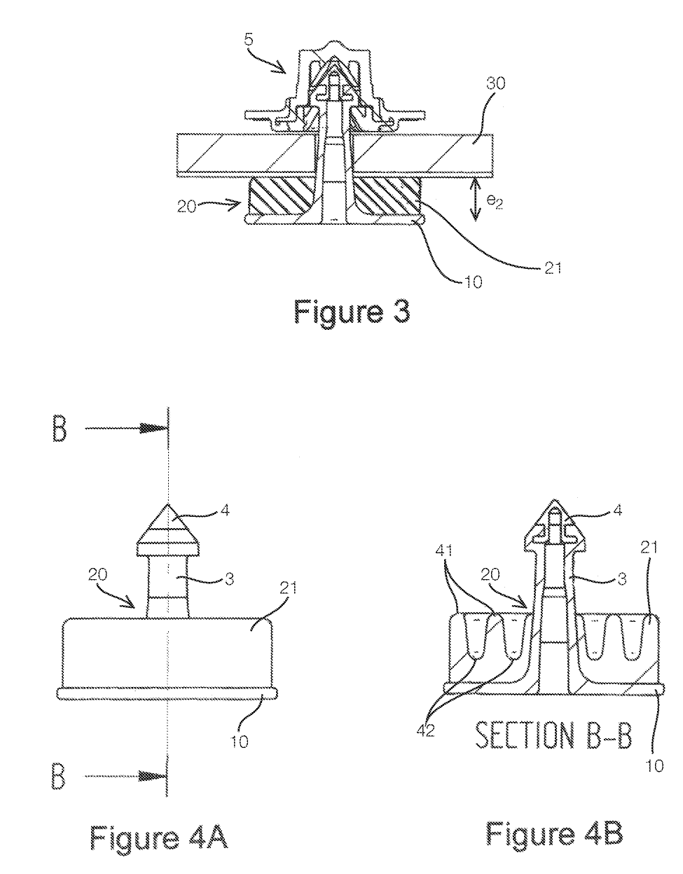

FIG. 3 shows the marking device according to this first embodiment, affixed to the ear 30 of an animal.

More precisely, upon the application of the tag, the foam 21 is compressed between the base 10 and the ear 30, and therefore has a thickness e₂, with e₂<e₁. The specific substance contained in the foam 21 being released when the foam is squashed, it enters directly into contact with the skin of the animal, and the opening made in the ear of the animal. Indeed, the pin 3 is used as a guide to guide the substance through the opening made in the ear 30 of the animal. As such, in the case where this substance is an antiseptic substance, this makes it possible to disinfect the wound formed by the application of the tag.

FIGS. 4A and 4B show respectively a profile view of the male component 20 of the marking device, and a cross-section view according to the section BB of this same component, according to an alternative embodiment.

According to this alternative, the foam 21 has several hollows 42 on its upper face, i.e. on the face of the foam that will come into contact with the skin of the animal upon the application of the tag.

For example, these hollows form concentric crowns, centred on the pin 3. As such, the foam 21 is formed of concentric bumps 41 and hollows 42, making it possible in particular to reduce the contact of the foam 21 on the ear 30 of the animal. The quantity of foam and of substance needed are as such reduced, while still allowing for a better distribution of the specific substance. In addition, the presence of hollows can make it possible to improve the circulation of the air between the marking device and the ear of the animal, as such favouring the cicatrisation of the wound.

Upon the application of the tag, the foam 21 is compressed between the base 10 and the ear 30. The specific substance contained in the foam 21 is then released, in contact with the skin of the animal, on the bumps 41.

According to another alternative not shown, the foam is formed of several portions (or sections) partially surrounding the pin. Such a foam is for example used for animals with fragile ears.

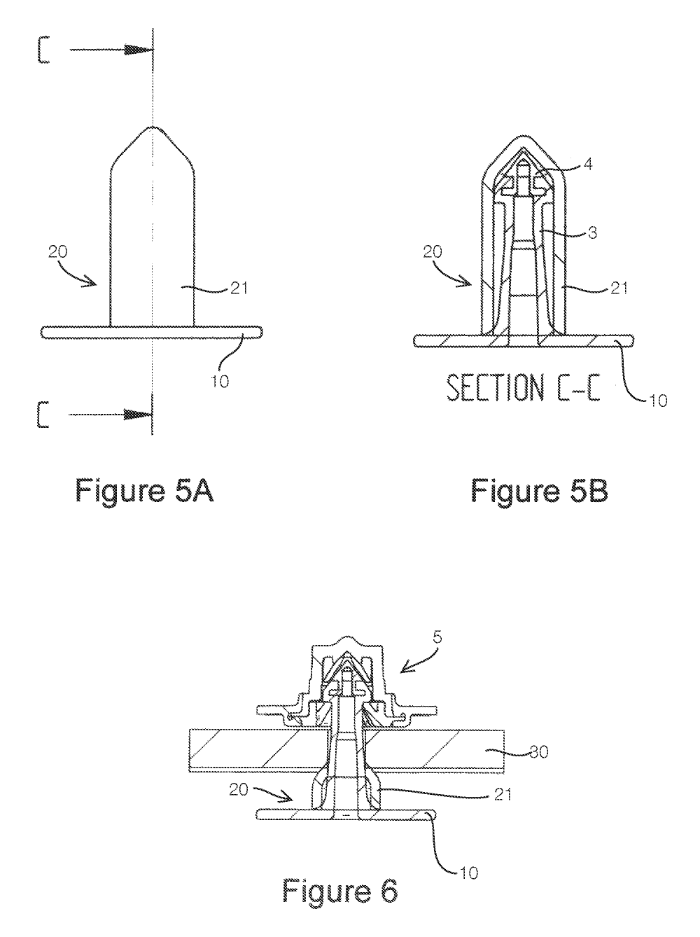

Finally, FIGS. 5A and 5B show a second embodiment, according to which the foam 21 covers the end of the pin 3.

More precisely, FIG. 5A shows a profile view of the male component 20 of a marking device according to this embodiment of the invention, and FIG. 5B shows a cross-section view according to the section CC of this same component.

According to this second embodiment, the pin 3 is surrounded with a foam 21 impregnated with a specific substance, also covering the tip 4.

As such, as shown in FIGS. 5A and 5B, the foam 21 forms a tube along the pin 3, closed on the tip 4. The tip 4 is therefore protected from the outside environment before the application of the tag.

As already indicated, the specific substance can be an antiseptic substance. The foam 21 covering the tip 4 therefore allows the tip 4 to be sanitized, before the application of the tag.

More precisely, upon the application, the tip 4 pierces the foam 21, then the ear 30 of the animal, before becoming housed, irreversibly, in the cavity of the female component 5.

As shown in FIG. 6, the foam 21 located along the pin 3 is also squashed upon the application between the base 10 and the ear 30, thus releasing the specific substance. The specific substance contained in the foam 21 therefore enters directly into contact with the skin of the animal. If this substance is an antiseptic substance, it makes it possible to disinfect or even sterilise the wound formed by the application of the tag.

Such a technique can also be used to inject a vaccine or a medication into an animal, by impregnating the foam with such a substance.

In order to avoid the evaporation or the drying of the substance impregnating the foam, a protective film can be provided on the male component.

According to an alternative, the pin is surrounded at least partially with a “dry” foam, i.e. which is not impregnated in advance with a specific substance. The user then impregnates the foam with the specific substance before installing the tag, for example by soaking the foam in an antiseptic substance.

1. A marking device for identifying and marking an animal, associating in a snap locking arrangement and comprising:
a male component (20) including a pin (3) extending from a base (10), and
a female component (5) including a cavity intended to interact with said pin (3);
wherein the pin (3) is surrounded at least partially with a foam (21) that is configured to be compressed between the skin of the animal to be marked and the base, and is configured able to release a specific substance in contact with the wound formed by the pin, upon the locking of the male and female components.

2. The marking device according to claim 1, wherein the specific substance is selected from the group consisting of:
an antiseptic substance;
a medication; and
a vaccine.

3. The marking device according to claim 1, wherein a lower face of said foam (21) is fastened to said base (10).

4. The marking device according to claim 2, wherein the foam (21) at least partially surrounds said pin (3), over a thickness from the lower face to an upper face that is less than or equal to the length of said pin (3).

5. The marking device according to claim 4, wherein the foam (21) has at least one hollow (42) on an upper face of said foam, opposite said base.

6. The marking device according to claim 19, wherein the at least one hollow (42) forms at least one concentric crown around said pin (3).

7. The marking device according to claim 1, wherein the foam (21) covers the end of said pin (3) opposite said base (10).

8. The marking device according to claim 1, wherein the foam (21) is protected by a protective film.

9. The marking device according to claim 1, wherein the marking device is an ear tag.

10. A male component of a marking device for identifying and marking an animal, where the male component is configured to snap lock with a female component including a cavity, the male component comprising:
a male component (20) including a pin (3) extending from a base (10), and
wherein the pin (3) is surrounded at least partially with a foam (21) configured to be compressed between the skin of the animal to be marked and the base, and is able configured to release a specific substance in contact with the wound formed by the pin, upon the locking of the male component with a female component.

11. The male component according to claim 10, wherein the specific substance is selected from the group consisting of:
an antiseptic substance;
a medication; and
a vaccine.

12. The male component according to claim 10, wherein a lower face of said foam (21) is fastened to said base (10).

13. The male component according to claim 10 wherein the foam (21) at least partially surrounds said pin (3), over a thickness from the lower face to an upper face that is less than or equal to the length of said pin (3).

14. The male component according to claim 13, wherein the foam (21) has at least one hollow (42) on an upper face of said foam, opposite said base.

15. The male component according to claim 14, wherein the foam (21) fully surrounds said pin (3).

16. The male component according to claim 15, wherein the at least one hollow (42) forms at least one concentric crown around said pin (3).

17. The male component according to claim 10, wherein the foam (21) covers the end of said pin (3) opposite said base (10).

18. The male component according to claim 10, wherein the foam (21) is protected by a protective film.

19. The marking device according to claim 5, wherein the foam (21) fully surrounds said pin (3).
